(19) United States
(12) Patent Application Publication
(10) Pub. No.: US 2025/0185150 A1
(43) Pub. Date: Jun. 5, 2025

(54) PARTICLE BEAM ASSISTED FUSED DEPOSITION MODELING

(71) Applicant: FERMI RESEARCH ALLIANCE, LLC, Batavia, IL (US)

(72) Inventor: Aaron Sauers, Batavia, IL (US)

(21) Appl. No.: 18/839,995

(22) PCT Filed: Feb. 22, 2023
(86) PCT No.: PCT/US2023/013640

§ 371 Date: Aug. 20, 2024

Related U.S. Application Data
(60) Provisional application No. 63/314,922, filed on Feb. 28, 2022.

(51) Int. Cl. H05H 7/00; B28B 1/00; B28B 11/24; B28B 17/00; B33Y 10/00; B33Y 30/00; B33Y 50/02

(52) U.S. Cl. CPC H05H 7/001; B28B 1/001; B28B 11/245; B28B 17/0081; B33Y 10/00; B33Y 30/00; B33Y 50/02; H05H 2007/002

(57) ABSTRACT

Methods and systems for electron beam assisted fused deposition modeling can include a particle accelerator configured to generate a particle beam, a shield cone and a magnet configured to direct the particle beam in the shield cone forming a beam extraction assembly configured to direct the terminal position of the particle beam on filament deposited by an additive manufacturing system, and a control system for controlling the beam spot location of the particle beam on the filament, such that the particle accelerator delivers a dose of irradiation along the build path according to the assigned irradiation value with the particle beam.

### CROSS REFERENCE TO RELATED PATENT APPLICATIONS

This patent application claims priority under 35 U.S.C. § 119(e) to, and the benefit of, U.S. provisional patent application 63/314,922 entitled “PARTICLE BEAM ASSISTED FUSED DEPOSITION MODELING”, which was filed on Feb. 28, 2022.

U.S. Provisional Patent Application Ser. No. 63/314,922 is incorporated herein by reference in its entirety.

### STATEMENT OF GOVERNMENT RIGHTS

The invention described in this patent application was made with Government support under the Fermi Research Alliance, LLC, Contract Number DE-AC02-07CH11359 awarded by the U.S. Department of Energy. The Government has certain rights in the invention.

### TECHNICAL FIELD

Embodiments are related to the field of construction and manufacturing. Embodiments are also related to additive manufacturing. Embodiments are further related to the field of fused deposition modeling. Embodiments are further related to control systems for fused deposition modeling applications. Embodiments are also related to accelerators, including electron accelerators. Embodiments are also related to the field of mobile accelerators. Embodiments are also related to curing extrudable materials. Embodiments are further related the cross-linking of materials. Embodiments additionally relate to methods and systems for concrete manufacturing. Embodiments are further related to methods, systems, and apparatuses for electron beam assisted fused deposition modeling of concrete.

### BACKGROUND

A number of extrusion-based additive manufacturing processes exist in the construction industry. For example, extrusion-based additive manufacturing of concrete involves a “printable” cement-based material extruded through a nozzle to form a layered filamentous structure (Fused Deposition Modeling, or “FDM”). A number of systems exist to stack the extrusion filament, including robotic arms, gantry systems, and wire-suspended print heads. Existing systems require good control of the deposited build material.

The extruded material must facilitate ease of discharge through the nozzle, and the extrusion must maintain its shape after deposition, adhere to the other printed layers to provide adequate mechanical properties, and stack without collapsing. However, curing of the extruded build material takes place in the air, which can result in post-deposition deformations in the structure, especially under load from successive layers.

As such, there is a need to overcome the canonical tradeoff between extrudability and printability in FDM of concrete, as disclosed in the embodiments provided herein.

### SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the disclosed embodiments to provide a method, system, and apparatus for concrete manufacturing.

It is an aspect of the disclosed embodiments to provide methods and systems for manufacturing via fused deposition modeling.

It is an aspect of the disclosed embodiments to provide methods and systems for electron beam assisted manufacturing.

It is an aspect of the disclosed embodiments to provide methods and systems for curing extruded manufacturing material with electron beams.

It is an aspect of the disclosed embodiments to provide methods and systems for cross-linking of materials.

It is an aspect of the disclosed embodiments to provide methods and systems for rapid electron beam assisted fused deposition modeling with concrete.

In accordance with the disclosed embodiments, a system comprises a particle source configured to generate a particle beam, a beam extraction assembly, the beam extraction assembly configured to direct the terminal position of the particle beam on a material deposited by a nozzle, and a control system for controlling a beam spot location of the particle beam.

In an exemplary embodiment a system comprises a particle source configured to generate a particle beam, a beam extraction assembly, the beam extraction assembly configured to direct the terminal position of the particle beam on a material deposited by a nozzle, and a control system for controlling a beam spot location of the particle beam. In an embodiment, the particle source comprises a particle accelerator. In an embodiment, the particle accelerator comprises an electron beam accelerator. In an embodiment, the particle beam comprises an electron beam. In an embodiment, the beam extraction assembly comprises a shield cone and a magnet configured to direct the particle beam in the shield cone. In an embodiment, the shield cone further comprises an inner cone, an outer cone, and a cutaway in the shield cone configured to accept the nozzle. In an embodiment the system further comprises a magnet configured in the shield cone to adjust an angle of the particle beam as it exits the shield cone. In an embodiment the system comprises a sensor array configured along the shield cone. In an embodiment, the beam bending assembly comprises a mechanically rotating assembly for the magnet that rotates about a vertical axis of the beam extraction assembly, bending the particle beam. In an embodiment of the system, the nozzle comprises an extrusion nozzle associated with an additive manufacturing system. In an embodiment, the beam spot location of the particle beam is directed on a filament deposited by the extrusion nozzle.

In another embodiment, a fabrication method comprises defining a desired build structure, translating the desired build structure into a build path, assigning an irradiation value along the build path sufficient to cure a build material, and delivering a dose of irradiation along the build path according to the assigned irradiation value with a particle beam. In an embodiment of the method, delivering the dose of irradiation comprises generating the particle beam with a particle accelerator. In an embodiment, the method comprises adjusting a beam angle of the particle beam according to said assigned irradiation value. In an embodiment, the accelerator comprises an electron beam accelerator. In an embodiment, the method comprises directing the particle beam along the build path, wherein the build path is defined by deposition of the build material.

In another embodiment, an apparatus comprises a particle accelerator configured to generate a particle beam, a beam extraction assembly comprising a shield cone and a magnet configured to direct the particle beam in the shield cone, the beam extraction assembly configured to direct the terminal position of the particle beam on a material deposited by a nozzle, and a control system for controlling a beam spot location of the particle beam. In an embodiment of the apparatus, the shield cone further comprises an inner cone, an outer cone, and a cutaway in the shield cone configured to accept the nozzle. In an embodiment of the apparatus, the control system is configured to assign an irradiation value along a build path sufficient to cure the material deposited by the nozzle, and instruct the particle accelerator to deliver a dose of irradiation along the build path according to the assigned irradiation value with the particle beam. In an embodiment, further comprises a window configured between the outer cone and the inner cone.

### BRIEF DESCRIPTION OF THE DRAWINGS

The accompanying figures, in which like reference numerals refer to identical or functionally similar elements throughout the separate views and which are incorporated in and form a part of the specification, further illustrate the embodiments and, together with the detailed description, serve to explain the embodiments disclosed herein.

FIG. 1 depicts a block diagram of a computer system which is implemented in accordance with the disclosed embodiments;

FIG. 2 depicts a graphical representation of a network of data-processing devices in which aspects of the present embodiments may be implemented;

FIG. 3 depicts a computer software system for directing the operation of the data-processing system depicted in FIG. 1, in accordance with an embodiment;

FIG. 4 depicts a perspective cut-away view of RF structures that can form elements of an electron accelerator that can be adapted for use in accordance with a preferred embodiment;

FIG. 5 depicts a cross-sectional elevation view of a superconducting RF structure that can also form elements of an electron accelerator adapted for use in accordance with an embodiment. The figure indicates the operating principles of such an elliptical RF cavity;

FIG. 6A depicts a system for curing build material, in accordance with the disclosed embodiments;

FIG. 6B depicts the system for curing build material and an associated build system, in accordance with the disclosed embodiments;

FIG. 6C depicts application of the system for curing build material, in accordance with the disclosed embodiments;

FIG. 7A depicts a beam spot diagram associated with a system for curing build material, in accordance with the disclosed embodiments;

FIG. 7B depicts the alternative system for curing build material, in accordance with the disclosed embodiments;

FIG. 7C depicts an interrogation assembly, in accordance with the disclosed embodiments;

FIG. 8A depicts another system for curing build material, in accordance with the disclosed embodiments;

FIG. 8B depicts application of the system for curing build material, in accordance with the disclosed embodiments;

FIG. 9 depicts a vertical system for curing build material, in accordance with the disclosed embodiments;

FIG. 10A depicts another system for curing build material and an associated build system with an angled nozzle, in accordance with the disclosed embodiments;

FIG. 10B depicts the application of the system for curing build material, in accordance with the disclosed embodiments;

FIG. 11 depicts a mechanical system for curing build material and an associated build system with an angled nozzle, in accordance with the disclosed embodiments;

FIG. 12A depicts a vehicle-based system for curing build material, in accordance with the disclosed embodiments;

FIG. 12B depicts the application of the vehicle-based system for curing build material, in accordance with the disclosed embodiments;

FIG. 13A depicts a control system, in accordance with the disclosed embodiments;

FIG. 13B depicts another control system, in accordance with the disclosed embodiments;

FIG. 14A depicts steps in a method for curing build material with the disclosed systems, in accordance with the disclosed embodiments;

FIG. 14B depicts a diagram of control dynamics, in accordance with the disclosed embodiments;

FIG. 15A depicts steps in another method for curing build material with the disclosed systems, in accordance with the disclosed embodiments;

FIG. 15B depicts steps in another method for curing build material with the disclosed systems, in accordance with the disclosed embodiments;

FIG. 16A depicts steps in another method for incrementally curing build material with the disclosed systems, in accordance with the disclosed embodiments; and

FIG. 16B depicts a diagram showing incremental curing of build material with the disclosed methods, in accordance with the disclosed embodiments.

### DETAILED DESCRIPTION

The particular values and configurations discussed in the following non-limiting examples can be varied, and are cited merely to illustrate one or more embodiments and are not intended to limit the scope thereof.

Example embodiments will now be described more fully hereinafter with reference to the accompanying drawings, in which illustrative embodiments are shown. The embodiments disclosed herein can be embodied in many different forms and should not be construed as limited to the embodiments set forth herein; rather, these embodiments are provided so that this disclosure will be thorough and complete, and will fully convey the scope of the embodiments to those skilled in the art. Like numbers refer to like elements throughout.

The terminology used herein is for the purpose of describing particular embodiments only and is not intended to be limiting. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. In addition, the term “based on” may be understood as not necessarily intended to convey an exclusive set of factors and may, instead, allow for existence of additional factors not necessarily expressly described, again, depending at least in part on context.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Some or all aspects of any embodiment disclosed herein may be incorporated with other embodiments without departing from the scope disclosed herein.

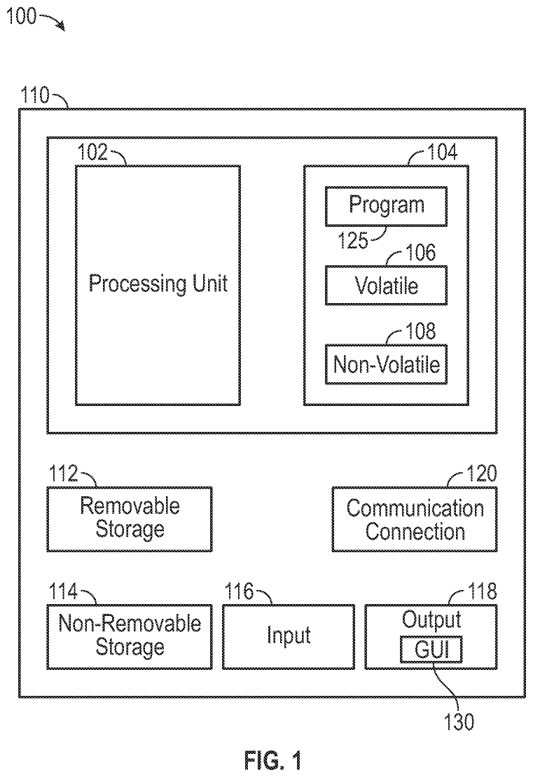

FIGS. 1-3 are provided as exemplary diagrams of data-processing environments in which embodiments of the present invention may be implemented. It should be appreciated that FIGS. 1-3 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

A block diagram of a computer system 100 that executes programming for implementing parts of the methods and systems disclosed herein is shown in FIG. 1. A computing device in the form of a computer 110 configured to interface with sensors, peripheral devices, and other elements disclosed herein may include one or more processing units 102, memory 104, removable storage 112, and non-removable storage 114. Memory 104 may include volatile memory 106 and non-volatile memory 108. Computer 110 may include or have access to a computing environment that includes a variety of transitory and non-transitory computer-readable media such as volatile memory 106 and non-volatile memory 108, removable storage 112 and non-removable storage 114. Computer storage includes, for example, random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage, or other magnetic storage devices, or any other medium capable of storing computer-readable instructions as well as data including image data.

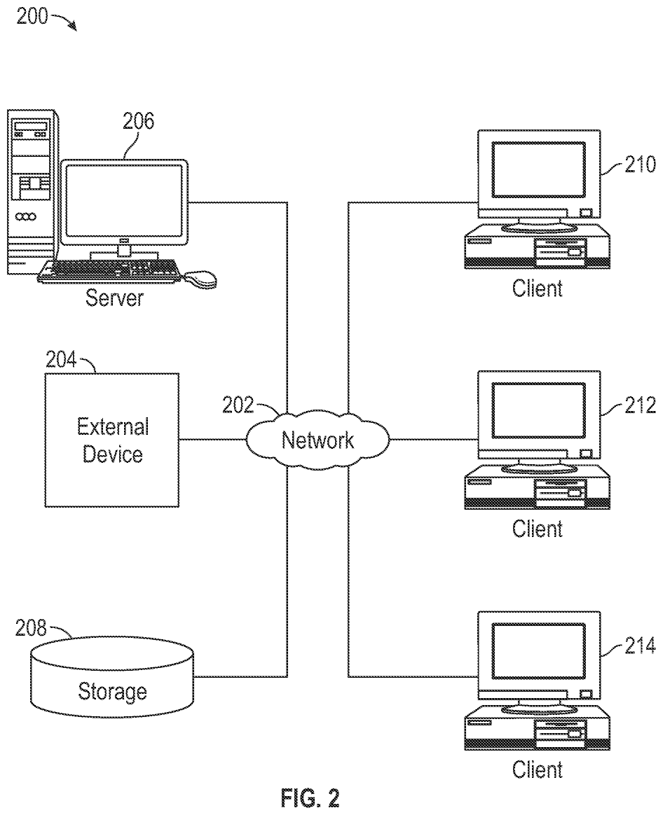

Computer 110 may include or have access to a computing environment that includes input 116, output 118, and a communication connection 120. The computer may operate in a networked environment using a communication connection 120 to connect to one or more remote computers, remote sensors, detection devices, hand-held devices, multi-function devices (MFDs), mobile devices, tablet devices, mobile phones, Smartphones, or other such devices. The remote computer may also include a personal computer (PC), server, router, network PC, RFID enabled device, a peer device or other common network node, or the like. The communication connection may include a Local Area Network (LAN), a Wide Area Network (WAN), Bluetooth connection, or other networks. This functionality is described more fully in the description associated with FIG. 2 below.

Output 118 is most commonly provided as a computer monitor, but may include any output device. Output 118 and/or input 116 may include a data collection apparatus associated with computer system 100. In addition, input 116, which commonly includes a computer keyboard and/or pointing device such as a computer mouse, computer track pad, or the like, allows a user to select and instruct computer system 100. A user interface can be provided using output 118 and input 116. Output 118 may function as a display for displaying data and information for a user, and for interactively displaying a graphical user interface (GUI) 130.

Note that the term “GUI” generally refers to a type of environment that represents programs, files, options, and so forth by means of graphically displayed icons, menus, and dialog boxes on a computer monitor screen. A user can interact with the GUI to select and activate such options by directly touching the screen and/or pointing and clicking with a user input device 116 such as, for example, a pointing device such as a mouse and/or with a keyboard. A particular item can function in the same manner to the user in all applications because the GUI provides standard software routines (e.g., module 125) to handle these elements and report the user's actions. The GUI can further be used to display the electronic service image frames as discussed below.

Computer-readable instructions, for example, program module or node 125, which can be representative of other modules or nodes described herein, are stored on a computer-readable medium and are executable by the processing unit 102 of computer 110. Program module or node 125 may include a computer application. A hard drive, CD-ROM, RAM, Flash Memory, and a USB drive are just some examples of articles including a computer-readable medium.

FIG. 2 depicts a graphical representation of a network of data-processing systems 200 in which aspects of the present invention may be implemented. Network data-processing system 200 is a network of computers or other such devices such as mobile phones, smartphones, sensors, detection devices, controllers, and the like in which embodiments of the present invention may be implemented. Note that the system 200 can be implemented in the context of a software module such as program module 125. The system 200 includes a network 202 in communication with one or more clients 210, 212, and 214. Network 202 may also be in communication with one or more device 204, servers 206, and storage 208. Network 202 is a medium that can be used to provide communications links between various devices and computers connected together within a networked data processing system such as computer system 100. Network 202 may include connections such as wired communication links, wireless communication links of various types, fiber optic cables, quantum, or quantum encryption, or quantum teleportation networks, etc. Network 202 can communicate with one or more servers 206, one or more external devices such as a controller, actuator, sensor, or other such device 204, and a memory storage unit such as, for example, memory or database 208. It should be understood that device 204 may be embodied as a detector device, microcontroller, controller, receiver, transceiver, or other such device.

In the depicted example, device 204, server 206, and clients 210, 212, and 214 connect to network 202 along with storage unit 208. Clients 210, 212, and 214 may be, for example, personal computers or network computers, handheld devices, mobile devices, tablet devices, smartphones, personal digital assistants, microcontrollers, recording devices, MFDs, etc. Computer system 100 depicted in FIG. 1 can be, for example, a client such as client 210 and/or 212.

Computer system 100 can also be implemented as a server such as server 206, depending upon design considerations. In the depicted example, server 206 provides data such as boot files, operating system images, applications, and application updates to clients 210, 212, and/or 214. Clients 210, 212, and 214 and external device 204 are clients to server 206 in this example. Network data-processing system 200 may include additional servers, clients, and other devices not shown. Specifically, clients may connect to any member of a network of servers, which provide equivalent content.

In the depicted example, network data-processing system 200 is the Internet with network 202 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, government, educational, and other computer systems that route data and messages. Of course, network data-processing system 200 may also be implemented as a number of different types of networks such as, for example, an intranet, a local area network (LAN), or a wide area network (WAN). FIGS. 1 and 2 are intended as examples and not as architectural limitations for different embodiments of the present invention.

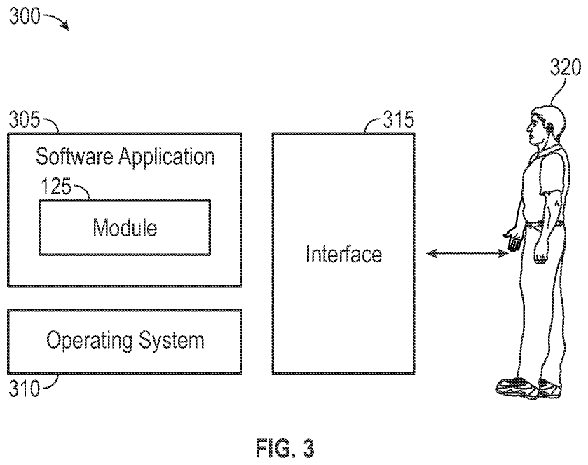

FIG. 3 illustrates a software system 300, which may be employed for directing the operation of the data-processing systems such as computer system 100 depicted in FIG. 1. Software application 305, may be stored in memory 104, on removable storage 112, or on non-removable storage 114 shown in FIG. 1, and generally includes and/or is associated with a kernel or operating system 310 and a shell or interface 315. One or more application programs, such as module(s) or node(s) 125, may be “loaded” (i.e., transferred from removable storage 114 into the memory 104) for execution by the data-processing system 100. The data-processing system 100 can receive user commands and data through user interface 315, which can include input 116 and output 118, accessible by a user 320. These inputs may then be acted upon by the computer system 100 in accordance with instructions from operating system 310 and/or software application 305 and any software module(s) 125 thereof.

Generally, program modules (e.g., module 125) can include, but are not limited to, routines, subroutines, software applications, programs, objects, components, data structures, etc., that perform particular tasks or implement particular abstract data types and instructions. Moreover, those skilled in the art will appreciate that elements of the disclosed methods and systems may be practiced with other computer system configurations such as, for example, hand-held devices, mobile phones, smart phones, tablet devices, multi-processor systems, printers, copiers, fax machines, multi-function devices, data networks, microprocessor-based or programmable consumer electronics, networked personal computers, minicomputers, mainframe computers, servers, medical equipment, medical devices, and the like.

Note that the term module or node as utilized herein may refer to a collection of routines and data structures that perform a particular task or implements a particular abstract data type. Modules may be composed of two parts: an interface, which lists the constants, data types, variables, and routines that can be accessed by other modules or routines; and an implementation, which is typically private (accessible only to that module), and which includes source code that actually implements the routines in the module. The term module may also simply refer to an application such as a computer program designed to assist in the performance of a specific task such as word processing, accounting, inventory management, etc., or a hardware component designed to equivalently assist in the performance of a task.

The interface 315 (e.g., a graphical user interface 130) can serve to display results, whereupon a user 320 may supply additional inputs or terminate a particular session. In some embodiments, operating system 310 and GUI 130 can be implemented in the context of a “windows” system. It can be appreciated, of course, that other types of systems are possible. For example, rather than a traditional “windows” system, other operation systems such as, for example, a real time operating system (RTOS) more commonly employed in wireless systems may also be employed with respect to operating system 310 and interface 315. The software application 305 can include, for example, module(s) 125, which can include instructions for carrying out steps or logical operations such as those shown and described herein.

The following description is presented with respect to embodiments of the present invention, which can be embodied in the context of, or require the use of a data-processing system such as computer system 100, in conjunction with program module 125, and data-processing system 200 and network 202 depicted in FIGS. 1-3. The present invention, however, is not limited to any particular application or any particular environment. Instead, those skilled in the art will find that the systems and methods of the present invention may be advantageously applied to a variety of system and application software including database management systems, word processors, and the like. Moreover, the present invention may be embodied on a variety of different platforms including Windows, Macintosh, UNIX, LINUX, Android, Arduino, and the like. Therefore, the descriptions of the exemplary embodiments, which follow, are for purposes of illustration and not considered a limitation.

U.S. Pat. No. 9,186,645, titled “METHOD AND SYSTEM FOR IN-SITU CROSS LINKING OF POLYMERS, BITUMEN AND SIMILAR MATERIALS TO INCREASE STRENGTH, TOUGHNESS AND DURABILITY VIA IRRADIATION WITH ELECTRON BEAMS FROM MOBILE ACCELERATORS,” issued on Nov. 17, 2015 describes systems and methods for treating and strengthening a material, the systems and methods comprising a mobile unit, an electron gun that emits a beam of electrons, an electron accelerator integrated with the mobile unit that is positioned to accelerate the beam of electrons, and a beam extraction device comprising a scan coil that emits the accelerated beam of electrons, where the beam extracting device is positioned on the mobile unit to irradiate the surface of, and treat in-situ, a material located proximate to the mobile unit, wherein irradiation of the material by the beam of electrons results in in-situ cross-linking of the material and therefore a strengthening and increased durability of the material. U.S. Pat. No. 9,186,645 is herein incorporated by reference in its entirety.

U.S. Pat. No. 9,340,931, titled “METHOD AND SYSTEM FOR IN-SITU CROSS LINKING OF POLYMERS, BITUMEN AND SIMILAR MATERIALS TO INCREASE STRENGTH, TOUGHNESS AND DURABILITY VIA IRRADIATION WITH ELECTRON BEAMS FROM MOBILE ACCELERATORS,” issued on May 17, 2016 describes systems and methods for treating and strengthening a material, the systems and methods comprising a mobile unit, an electron gun that emits a beam of electrons, an electron accelerator integrated with the mobile unit that is positioned to accelerate the beam of electrons, and a beam extraction device comprising a scan coil that emits the accelerated beam of electrons, where the beam extracting device is positioned on the mobile unit to irradiate the surface of, and treat in-situ, a material located proximate to the mobile unit, wherein irradiation of the material by the beam of electrons results in in-situ cross-linking of the material and therefore a strengthening and increased durability of the material. U.S. Pat. No. 9,340,931 is herein incorporated by reference in its entirety.

U.S. Pat. No. 10,070,509, titled “COMPACT SRF BASED ACCELERATOR,” issued on Sep. 4, 2018, describes a particle accelerator comprising an accelerator cavity, an electron gun, and a cavity cooler configured to at least partially encircle the accelerator cavity. A cooling connector and an intermediate conduction layer are formed between the cavity cooler and the accelerator cavity to facilitate thermal conductivity between the cavity cooler and the accelerator cavity. The embodiments disclosed therein teach a viable, compact, robust, high-power, high-energy electron-beam, or x-ray source. The disclosed advances are integrated into a single design, that enables compact, mobile, high-power electron accelerators. U.S. Pat. No. 10,070,509 is herein incorporated by reference in its entirety.

U.S. Pat. No. 11,123,921, titled “METHOD AND SYSTEM FOR CROSS-LINKING OF MATERIALS TO PRODUCE THREE-DIMENSIONAL FEATURES VIA ELECTRON BEAMS FROM MOBILE ACCELERATORS,” issued on Sep. 21, 2021, describes a particle accelerator used in combination with control and delivery systems to produce arbitrary functional or ornamental three-dimensional features. U.S. Pat. No. 11,123,921 is herein incorporated by reference in its entirety.

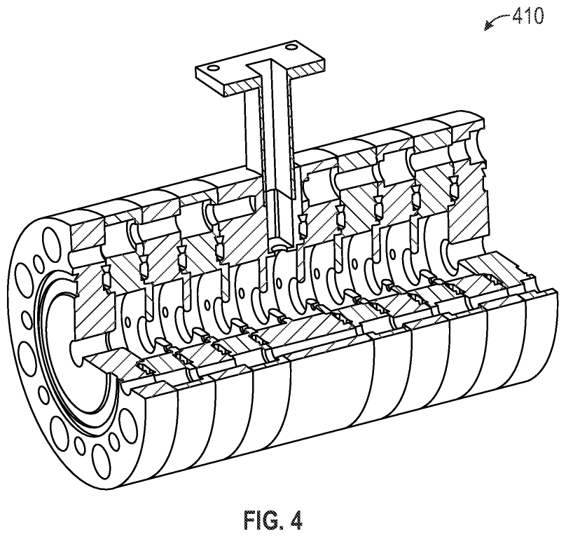

FIG. 4 illustrates a perspective cut-away view of an RF structure 410 that can form elements of an electron accelerator that can be adapted for use in accordance with embodiments disclosed herein. Note that RF accelerator and electron gun structures can be employed to produce electron beams of the required energy for implementation of the disclosed embodiments. An electron accelerator, for example, that employs the RF structure 410 can accelerate electrons generated from an electron gun with RF electric fields in resonant cavities sequenced such that the electrons are accelerated due to an electric field present in each cavity as the electron traverses the cavity to reach a beam extraction device.

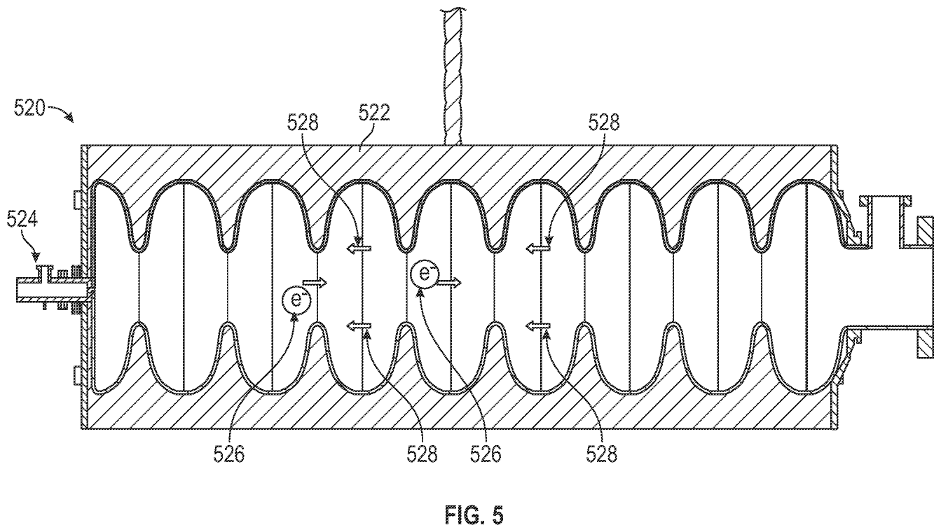

FIG. 5 illustrates an elevation cut-away view of an 8.5 cell elliptical superconducting RF structure 520 that can also form elements of an electron accelerator adapted for use in accordance with an embodiment. Note that varying embodiments can employ alternative cavity geometries and/or cell numbers. FIG. 5 generally indicates the operating principles of an elliptical RF cavity. Advancements in SRF technology can enable even more compact and efficient accelerators for this application.

The RF structure 520 of FIG. 5 demonstrates the principle of operation in which alternating RF electric fields can be arranged to accelerate groups of electrons timed to arrive in each cavity when the electric field in that cavity causes the electrons to gain additional energy. In the particular embodiment shown in FIG. 5, a voltage generator can induce an electric field within the RF cavity. Its voltage can oscillate, for example, with a radio frequency of 1.3 Gigahertz or 1.3 billion times per second. An electron source 524 can inject particles into the cavity in phase with the variable voltage provided by the voltage generator of the RF structure 520. Arrow(s) 526 shown in FIG. 5 indicate that the electron injection and cavity RF phase is adjusted such that electrons experience or “feel” an average force that accelerates them in the forward direction, while arrow(s) 528 indicate that electrons are not present in a cavity cell when the force is in the backwards direction. The structure 520 can be cooled with a conduction cooling system 522.

It can be appreciated that the example RF structures 410 and 520, respectively shown in FIGS. 4-5, represent examples only and that accelerators, including electron accelerators, of other types and configurations/structures/frequencies may be implemented in accordance with alternative embodiments. That is, the disclosed embodiments are not limited structurally to the example electron accelerator structures 410, 520, respectively shown in FIGS. 4-5, but represent merely one possible type of structure that may be employed with particular embodiments. Alternative embodiments may vary in structure, arrangement, frequency, and type of utilized accelerators, RF structures, and so forth.

Extrusion based additive manufacturing involves the extrusion of concrete-based material, or filament, through a nozzle. The “extrudability” of the material is determined by how easily it flows through the nozzle (Flowability). The “buildability” of the extruded filament is determined by its stiffness (a stiffer filament is better able to withstand the stresses of subsequent layers). These are competing characteristics, so the printability of the structure depends on a compromise between extrudability and buildability. In other words, the better the extrudability, the worse the buildability and vice versa. This is characterized in equations (1), (2), and (3) as follows:

$$Extrudability ( {P}_{e} ) = \frac{\frac{Flowability ( {D}_{S} )}{Time ( t )}}{\frac{Max ( {D}_{S} )}{Min ( t )}} \times 100 \% \qquad ( 1 )$$

$$Buildability ( {P}_{b} ) = \frac{\frac{Stiffness ( {P}_{r} )}{Slump ( {H}_{S} )}}{\frac{Max ( {P}_{r} )}{Min ( {H}_{S} )}} \times 100 \% \qquad ( 2 )$$

$$Printability ( {P}_{b} ) = {F}_{Optimal} ( {P}_{e} , {P}_{b} ) \qquad ( 3 )$$

The extrudability coefficient can be defined as the ratio of spreading diameter (Ds) and time interval t. Thus, the buildability is defined by the ratio of penetration resistance (Pr) to slump (Hs). Printability relies on the balance between the extrudability and buildability. The extrudability is inversely proportional to rest time, whereas the buildability increases with time. The disclosed embodiments decouple the mechanical properties of the extrusion from those of the filament, addressing the tradeoff between extrudability and buildability.

The embodiments disclosed herein are thus directed to electron beam assisted fused deposition modeling. In exemplary embodiments, a system and method for post-extrusion curing of concrete FDM filament with an electron beam is disclosed. The electron beam reduces the setting time of the filament. It should be noted that the filament can include curable binding materials, radiation-curable binders which can be crosslinked, and/or a radiation resistant heat curable binder, among other possible binders, which can be added to the pre-extrusion slurry. Electron beam curing of the extrusion enables use of a lower viscosity slurry to allow uninterrupted flow during extrusion, while the curing step confers high yield stress to the filament to prevent slumping of the material after deposition. Additionally, many binders do not auto-cure significantly without exposure to irradiation or heat, simplifying storage, cleanup, and handling of the materials.

In an embodiment, a system can comprise an electron source and beam extraction device designed to provide electrons to the filament trailing an extrusion nozzle. In an exemplary embodiment, the beam extraction device is “downstream” of the extrusion nozzle relative to the direction of material deposition. The beam extraction device is thus positioned to treat the material immediately following deposition, resulting in in-situ curing, setting, and/or crosslinking of the material and therefore improved strength and increased durability. The technique can be used to either fully-set the extruded material, or to partially-set the extruded material to increase stiffness while tackifying the surface, thereby improving interface adhesion.

The embodiments also promote faster construction, by reducing previous time limiting aspects of constructions. For example, curing of previous layers need not be a limiting factor on build speed. Likewise, in certain embodiments, curing may not be a limiting factor. Very large structures, for example, may have plenty of time before the extruder arrives back for the next layer. The disclosed embodiments allow different building strategies for a large structure. For example, additional layers can be built locally, or other such flexibility in design scheme can be realized, according to the disclosed embodiments.

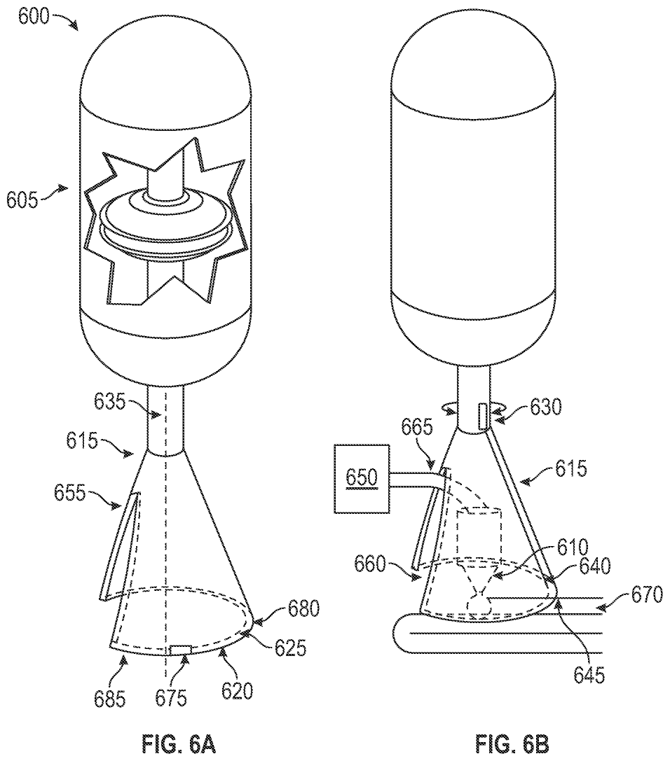

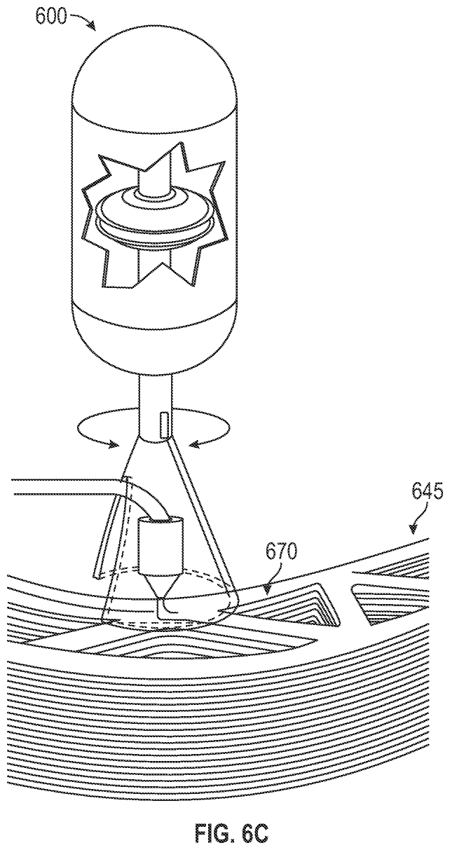

FIGS. 6A and 6B illustrate embodiments of a system 600 comprising an accelerator assembly 605 oriented directly above an extrusion nozzle 610. In certain embodiments, the accelerator assembly 605 can comprise a particle accelerator, which can be used to generate an electron beam 640, or other such particle beam. A beam extraction assembly 615 is illustrated in FIGS. 6A and 6B. The beam extraction assembly 615 can be a cone-shaped double-walled evacuated beam extraction device. The beam extraction assembly 615 can thus include a shield cone 655. The shield cone 655 comprises an outer cone 620 and a smaller inner cone 625, which serves to maintain a particle beam such as an electron beam, at or near vacuum, shield the extrusion nozzle 610 below the assembly, and shield the environment outside the beam extraction assembly 615.

A window 685 can be configured between the outer cone 620 and smaller inner cone 625. In certain embodiments, the window can be selected to have a low atomic number to minimize absorption of electrons, like Aluminum or Titanium. In other embodiments, the pressure differential may also necessitate a strong window 685 material. For example, in certain embodiments, Beryllium may be preferable because it has a relatively low atomic number and is very strong. A key consideration in selecting the material for window 685 is radiation length. Radiation length is a characteristic of a material related to the energy loss of high energy particles electromagnetically with which it is interacting. Beryllium has a low radiation length.

A mechanically rotating beam-bending assembly (or neck) 630 rotates about the vertical axis of the beam extraction assembly 615, bending the beam 640 away from the extrusion nozzle 610, around the cone, and onto the build plane 645. The beam bending assembly 630 can comprise a magnet which can be operably connected to an additive manufacturing system 650 and can be controlled via servo to trail the extrusion nozzle 610.

The shield/vacuum cone 655 can be raised or translated along the vertical/horizontal to facilitate servicing of the extrusion nozzle 610. Various mechanisms can be used for this purpose. In an exemplary embodiment, a hydraulic lift and rack can be used to allow the accelerator assembly to roll out and lock in an open position, either up to open or out to open. The open position can maintain support for the system safely. Alternatively, a mechanism for latching/unlatching the nozzle from a magazine in order to pull it out of the assembly can be used. These solutions are configured to allow access to the nozzle if necessary. This is essential if the nozzle needs to be switched out or serviced.

It should be noted that, in such embodiments, the beam 640 is incident on the build plate at an angle, which will reduce the penetration depth of the beam 640 as compared to a beam directly perpendicular to the build plate. As a result, in certain embodiments, the dimensions of the shield cone 655 and the associated beam energy can be selected to provide the desired beam penetration depth. Likewise, the control system further detailed herein, can be used to control the beam 640 power to account for the dimensions of the shield cone so that the desired beam 640 penetration is achieved.

It should be appreciated that in certain embodiments, a magnet 680 comprising a permanent magnet or electromagnet can be configured around the periphery to adjust (or correct) the angle of the beam 640 as it exits the shield cone 655. It should be appreciated that the angle of the beam may be advantageous in certain applications, so a movable beam corrector may be desirable. For example, in certain embodiment the beam can be made vertical at some points and moved to be at an angle at other points, or for example, for interrogation purposes.

The system 600 is configured to discharge electrons along a 360° arc, which allows irradiation of the deposited filament 670 while the extrusion nozzle 610 traverses its path along the 2-dimensional build plane 645. When the accelerator 605 and beam extraction device 615 are mounted to a 3D printing system 650, the degrees of freedom may be limited to less than 360°.

The shield cone 655 can comprise a cutaway 660 configured to allow aspects of an additive manufacturing system 650, such as a filament distribution line 665 to connect to the nozzle 610. The shield cone 655 is thus configured to accommodate the extrusion nozzle assembly 650 and hose, which may limit the degrees of freedom to roughly 300°. In this embodiment, a construction system logic controller or control module, as further detailed herein, can be programmed to take the optimal build path to ensure the electron beam 635 always trails the extrusion nozzle 610. As such, the system 600 can be operably connected to or associated with the additive manufacturing system 650.

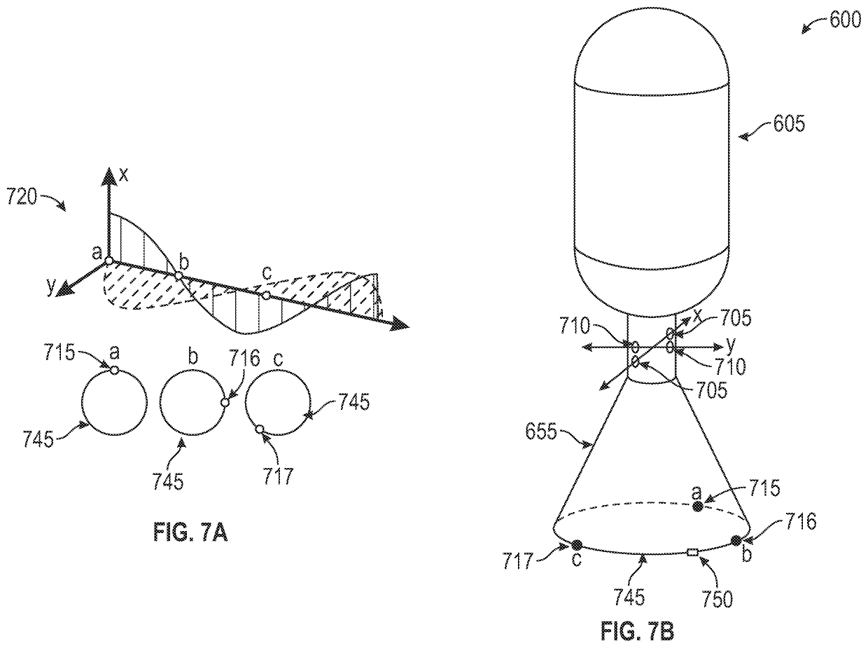

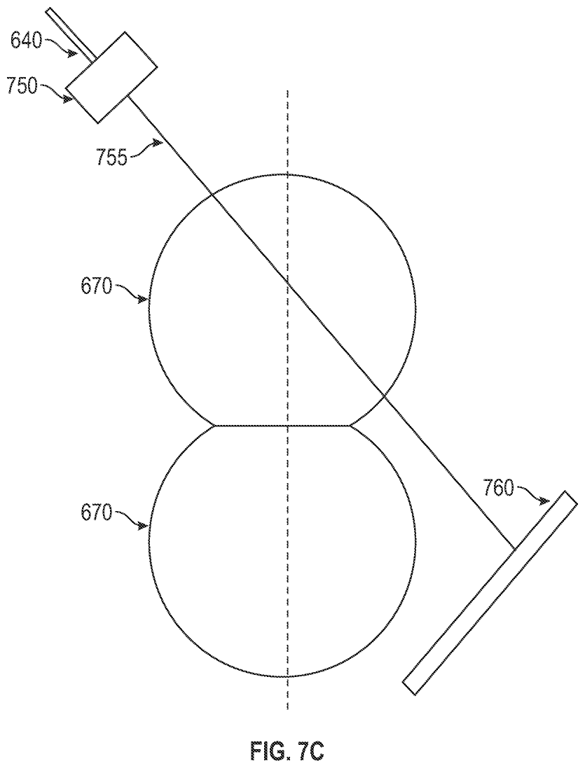

The extrusion nozzle 610 and accelerator assembly 605 can also be rotated along a common zedinal axis while remaining stationary with respect to each other. In this way, additional degrees of freedom to treat the trailing filament 670 are possible. In some environments, a proximate sensor or sensor array 675 can collect material data from scattered particles. Aspects are further detailed in FIG. 7C

As the nozzle 610 moves, it is necessary for the beam 640 to move accordingly so that the proper dose of beam 640 is applied to the extruded material. This can be achieved, as further detailed herein, with a logic control or control module. The logic control can control the location and/or size of the beam spot as the nozzle head 610 moves. This can be done with incoming location data provided by the additive manufacturing system, or can be translated from a build map used by the additive manufacturing system 650 to direct the location of the nozzle 610. In certain embodiments, the location of the beam can reciprocate, for example, as a sine wave, in order to cover broader extrusions, or unusual build paths. FIG. 6C illustrates the system 600 curing filament 670 along a build path 645.

FIGS. 7A and 7B illustrate another embodiment of a beam transport system 700. The beam transport system 700 includes an accelerator assembly 605, and further comprises a first dipole magnet 705 and a second dipole magnet 710. The two dipole magnet 705 and dipole magnet 710 are rotated by 90° with respect to each other. The first dipole magnet 705 and second dipole magnet 710 serve to deflect the beam 640 away from the extrusion nozzle 610 below. The dipole magnets 705 and 710 can be powered with a sine wave AC current such that one sweeps along the x axis, and the other along the y axis. The two frequencies and amplitudes are the same but 90° out of phase, thereby sweeping a cone around the extrusion nozzle 610. This is illustrated in FIG. 7A where two AC sine waves 90 degrees out of phase are shown in diagram 720. The beam pulses intersect with the build plane 465 at point A 715, point B 716, and point C 717 as illustrated.

As above, the shield cone 655, preferably comprising a cone-shaped double-walled evacuated chamber with an outer cone and a smaller inner cone, can serve both to maintain the beam in vacuum and to shield the extrusion nozzle below the assembly and the environment outside the assembly in beam transport system 700. As in FIG. 6, a window 685 can be configured between the outer cone 620 and smaller inner cone 625 of a shield cone 655

A control system as further detailed herein, which can be operably connected to the additive manufacturing system, pulses the accelerator to provide beam to the desired intersection with the build plane 645, for example at point A 715, point B 716, or point C 717. In a preferred implementation of this embodiment, the control system consistently delivers beam trailing the extrusion nozzle 610. Again, the extrusion nozzle 610 and accelerator assembly 605 can be rotated along a common zedinal axis while remaining stationary with respect to each other to secure additional degrees of freedom.

The advantage of this embodiment is that the beam spot can be directed to follow the build trail without moving parts. Additionally, other complex beam patterns are possible by varying frequencies and phases of the dipoles 705 and 710. The width of the beam “spot” can be tuned by varying the duration of the beam pulse. In other cases, this arrangement can be used to dose multiple filaments during a single pulse, or can simultaneously dose various spots such as point A 715, point B 716, and point C 717. In practice this provides the ability to efficiently dose difficult to reach filament. For example, if a spot in the filament were missed, or was otherwise unable to be dosed, the disclosed beam transport system can dose that spot while it's dosing the trailing filament. Likewise, in cases where interrogation is desirable, pulses meant for interrogation could be provided.

For example, FIG. 7C illustrates an interrogation assembly in accordance with the disclosed embodiments. A small portion of the shield cone 655 can have a bremsstrahlung target 750. A pulse can periodically be directed to the target 750 to produce an interrogation pulse to produce x-rays 755. External detectors 760 outside or underneath the assembly can be used to detect the x-rays for interrogation. The detector 760 can comprise a scintillator coupled to a CCD.

The interrogation assembly may be of particular value in unique build settings. In certain contexts, scattered electrons and secondary particles may be relevant, and it may be of some value to collect associated data. For example, such data may provide indicia regarding the filament that was just treated—especially if the build material is of an unknown type (e.g., gathered on the moon, or on another planet). This allows examination of the structure in great detail as it is being built.

For example, with a target 750, x-rays can be generated. In general x-rays have good penetration, with resulting scattering or transmission. The detectors 760 can be outside or underneath the structure. The detector can be a scintillator which creates flashes of light upon impact. The flashes can be collected by a CCD to produce an image.

It is noteworthy that where the angle of incidence is other than vertical, the system can be arranged such that x-rays are transmitted through the filament and exit the opposing side where they are detected with a scintillator. The beam can be configured to hit the target before hitting the filament, or in some cases a small but sufficient number of x-rays may be produced just by the beam interacting with the filament.

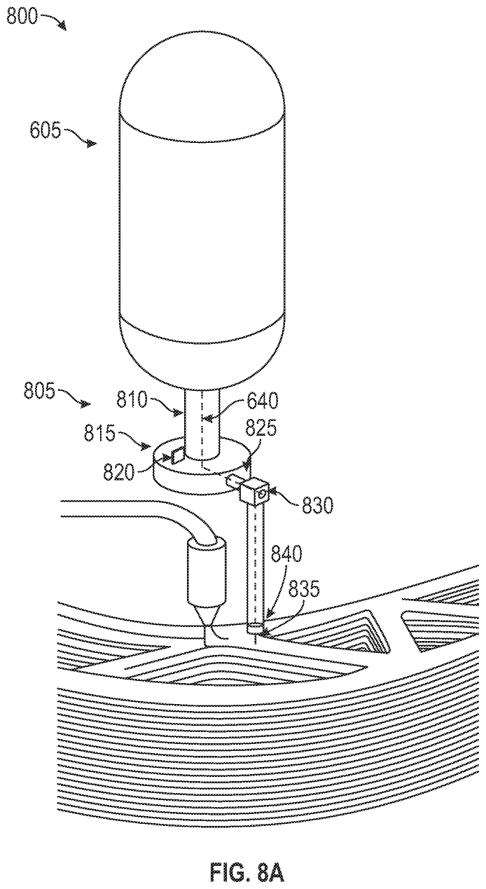

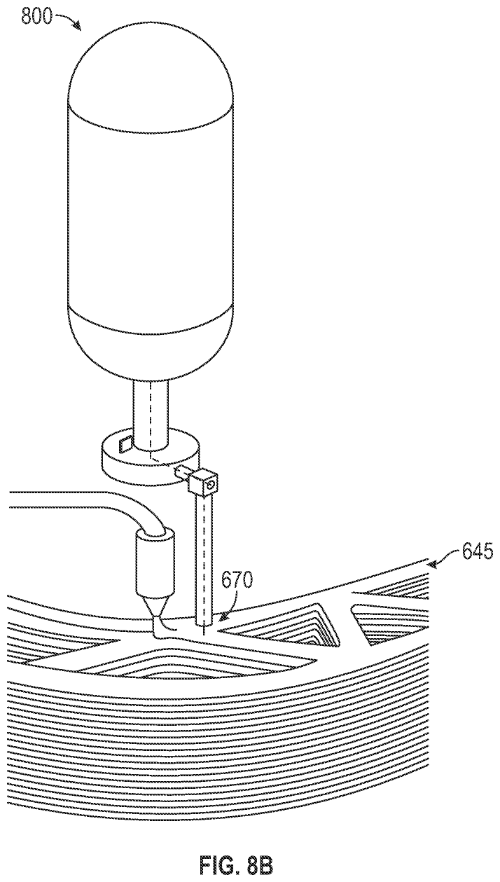

FIG. 8A illustrates another embodiment of a beam transport system 800 comprising a particle accelerator 605 and a mechanical beam extraction assembly 805 which can be mounted to the build system. In vertically-oriented accelerator applications, the beam extraction assembly 805 comprises a vertical evacuated beam transport tube 810, which passes through a rotatable vacuum seal 815. The rotatable vacuum seal 815 includes a bending magnet 820, which bends the beam 640 into a substantially evacuated beam tube 825. The evacuated beam tube 825 can rotate about the axis of the downward traveling particle beam 640. The evacuated beam tube 825 extends a given length from the center of rotation of the rotatable vacuum seal 815. The beam 640 is finally bent downward by a second beam bending magnet 830 and exits the assembly through a beam window 835.

It should be appreciated that the illustration of the beam transport system 800 is exemplary. Depending on the height, the evacuated beam tube 825 can be only a small angle away from vertical (although beam tube 825 is illustrated as horizontal it need not be). Indeed, the bending magnet needs to move the beam some distance R from the nozzle in order to give some degrees of rotation about the nozzle. In certain embodiment, this can be achieved with a relatively small angle. A smaller angle may be advantageous in certain embodiments, as the less the beam is bent, the less energy is lost prior to interacting with the material to be treated.

Optionally, the beam can be “fanned” with the addition of a scan horn assembly including a scan coil 840 prior to the beam exiting the beam extraction device through the beam window 835, which facilitates treatment of wider extrusion bead layers. In certain embodiments, the scan coil can comprise an electromagnetic coil, scanning electromagnet, an arrangement of permanent magnets, or the like, in spaced relation to the evacuated beam tube. In certain embodiments, one or more sections of the evacuated beam tube can be shaped as necessary for beam fanning. For example, the evacuated beam tube can be a cone-shaped vacuum chamber or a horn-shaped vacuum chamber. Other configurations and shapes are possible. For example, a rectangular or box-shaped evacuated beam tube is also possible.

The scan coil can be utilized to redirect the particle beam. The evacuated beam tube can be configured from materials that are transparent to the magnetic field of the scan coil 840 so that the scan coil 840 can fan the beam. The addition of a scan horn assembly as described allows 360 degree rotation of the beam including underneath the extrusion nozzle assembly and hose.

FIG. 8B illustrates the beam transport system 800 curing filament 670 along a build path 645.

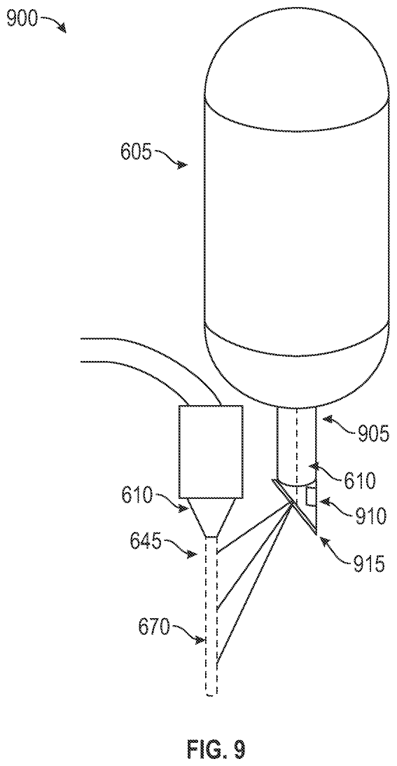

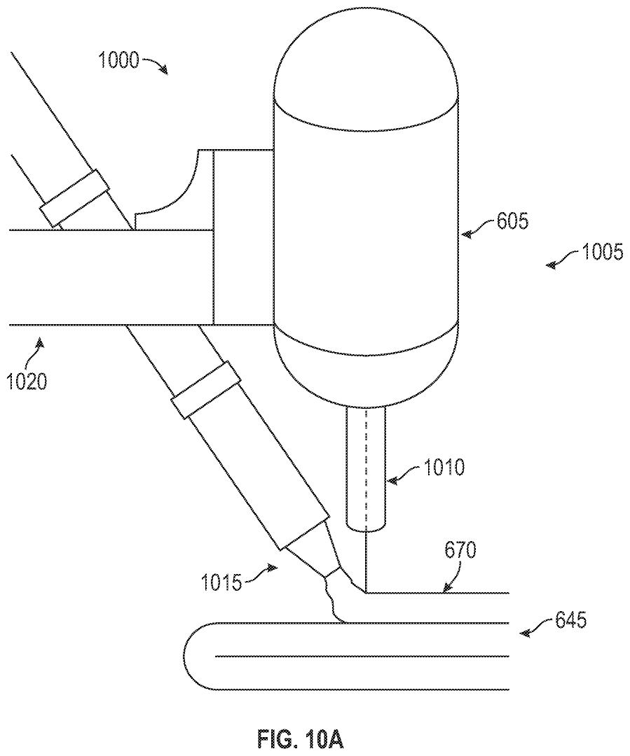

FIG. 9 illustrates another embodiment of a beam transport system 900. The beam transport system 900 includes a particle accelerator 605 with, a vertically-oriented evacuated beam transport tube 905 that terminates with a bending magnet 910 configured to direct the beam 640 to a user-defined distance below the extrusion nozzle 610 to cure filament 670 as it is laid upon the build surface 645. The bending magnet 910 can be configured to adjust the angle, and therefore terminal position, of the beam below the extrusion nozzle 610. One benefit of this embodiment is its ability to target the extruded filament irrespective of the nozzle build path direction along the 2-dimensional plane, which can include a horizontal, vertical, or angled plane.

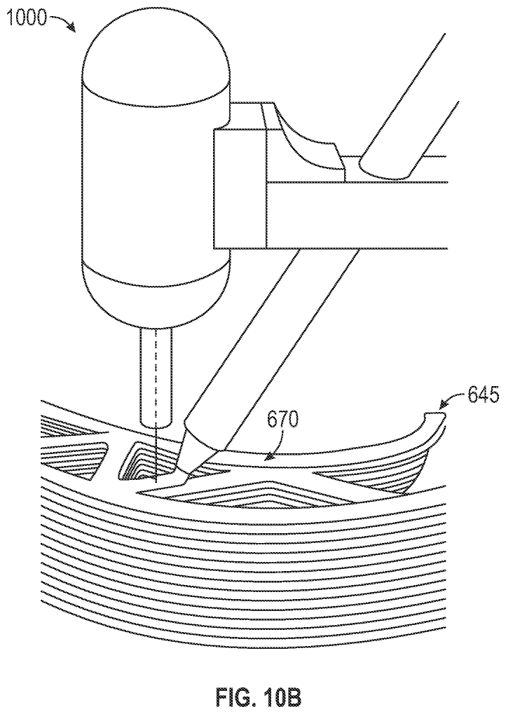

FIG. 10A illustrates another embodiment of a beam transport system 1000 where the beam extraction assembly 1005 comprises a mounting arm 1020 holding the particle accelerator 605 vertical, with an evacuated beam tube 1010; while the extrusion nozzle 1015 is angled so as to deposit the filament 670 onto the build surface 645 underneath, and intersecting with, the beam spot. FIG. 10B illustrates the beam transport system 1000 curing filament 670 along a build path 645.

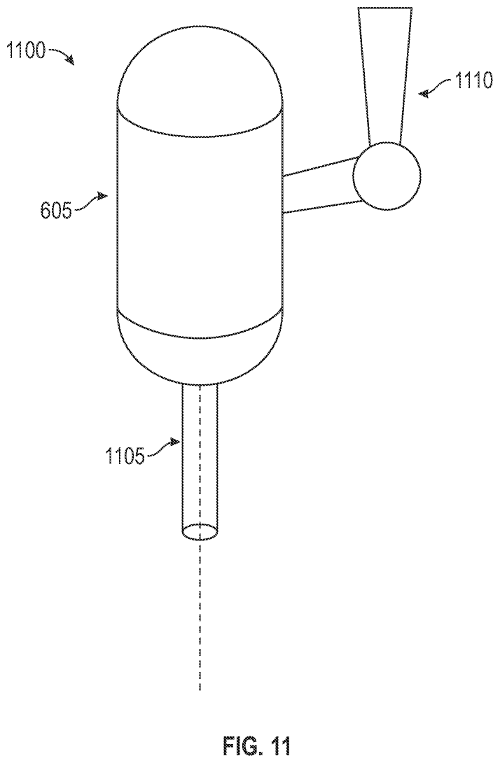

In certain embodiments, illustrated in FIG. 11, the beam transport system 1100 comprises a mechanically movable system. In such embodiments, the entire accelerator assembly 605 is configured with a simplified vertical beam pipe 1105. The accelerator assembly 605 rotates mechanically via a rotation assembly 1110 around the extrusion nozzle 610 to follow the build path.

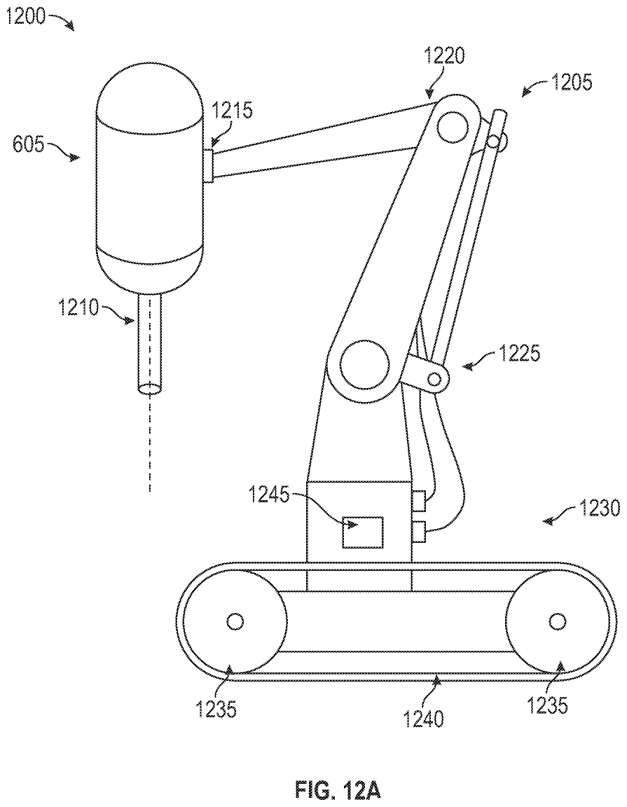

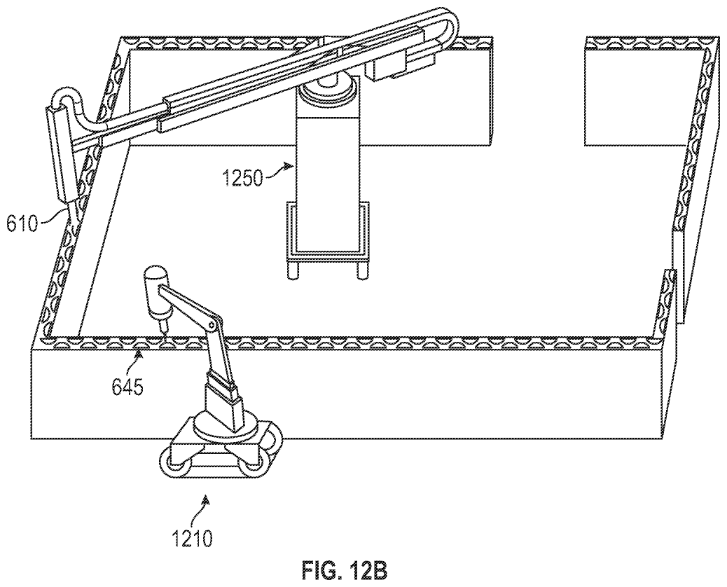

FIG. 12A illustrates an embodiment of a beam transport system 1200. The beam transport system 1200 can comprise an accelerator assembly 605 mounted to vehicle-borne system 1205 designed to follow and irradiate the extruded filament 670. The accelerator assembly 605 can include a beam pipe 1210.

In an exemplary embodiment, the vehicle-borne system 1205 can comprise an accelerator mounting bracket 1215. The mounting bracket 1215 can be further connected to a crane arm 1220. The crane arm 1220 can be hinged and can be further connected to a hydraulic or pneumatic drive 1225 which allows the crane arm to adjust the relative height of the accelerator assembly. This is necessary for additive manufacturing applications because the height of the filament will change as layers are added.

The vehicle-borne system 1205 further comprises a drive assembly 1230. The drive assembly can comprise one or more wheels 1235, which may or may not be drives for a track 1240. If a track 1240 is not included, the wheels can operate independently to propel the vehicle-borne system 1205. The drive assembly 1230 can further include a drive train, which can include an electric or gas powered motor configured to drive a drive shaft, which in turn drives the wheels 1235. The drive assembly 1230 can also include a receiver module 1245 for receiving instructions from a control module, indicating where the vehicle-borne system 1205 will move to track the extrusion from the nozzle 610. In certain embodiments, the vehicle-borne system 1205 can operate autonomously via instructions provided via the receiver module to track the progress of extrusion from the nozzle 610. In other embodiments, an operator can control the drive assembly via a user interface associated with a computer system. FIG. 12B illustrates a vehicle-borne system tracking an FDM extrusion module 1250, in accordance with the disclosed embodiments.

The aforementioned configurations are compatible with a range of currently available concrete FDM systems. An x-ray target (e.g., a Bremsstrahlung target) can be added to any of these arrangements to create x-rays as a result of the incident high-energy electron beam. X-ray treatment of the extrusion filament may be preferable in some applications.

When the crosslinkable material is exposed to the electron beam, the long-chain molecules of the polymer are ionized by electrons. The ionized polymer chains connect to each other, and a crosslinked polymer matrix is created. The polymer matrix has improved physical properties compared to original material.

Crosslinking can improve a number of material properties, including heat tolerance, tensile strength, and impact resistance. Radiation induced crosslinking can be applied to a number of plastics, though not all plastics can be crosslinked (there are radiation-resistant plastics that are unsuitable for electron beam crosslinking). Some plastics crosslink on their own, while some need a crosslinking agent. Radiation as disclosed herein can be used to eliminate the use of these chemical agents. There is a threshold energy for crosslinking and degradation (embrittlement) for most materials. Some polymers require less dose to be crosslinked than others, which can yield more cost-effective crosslinking than the use of chemicals. Chemical crosslinking agents can also be hazardous or otherwise undesirable.

The material to be irradiated may constitute a polymer; geopolymer; polymer composite; plastic; thermoplastic; plastic composite; elastomer; bitumen; modified bitumen; or an electron or x-ray crosslinkable bitumen product; stone, gravel, sand, or cement composite; polyethylene (HDPE, LDPE, LLDPE, UHMWPE, etc.); ethylene copolymers (EVA, Surlyn, etc.); chlorinated polyethylene (CPE); polyacrylate; polymethyl methacrylate (PMMA); rubbers (natural, synthetic, silicone, nitrile, etc.); polyamides; fluoropolymers (PVF, ECTFE, PVDF, ETFE, etc.); nylon (PA6, PA6-6, PA12, etc.); polybutylene terephthalate (PBT); chlorosulfonated polyethylene (CSPE); polyurethane; polybutadiene; ethylene propylene diene monomer (EPDM); ethylene propylene rubber (EPR); styrene butadiene rubber (SBR); or any material capable of being cured, crosslinked, or its material properties modified with electron beams, x-rays, or by irradiation of the material.

It should be appreciated that the disclosed embodiments can be used to induce curing and/or in-situ crosslinking of the filament material. Accelerated curing may also be an advantage, even in cases where crosslinking is not taking place. Electron beam deposits heat deeply and can speed up the natural curing process. Deep penetrating beam energy can also accelerate chemical processes, and can accelerate thermoset cures. The embodiments can also be used for solvent-less thermal curing.

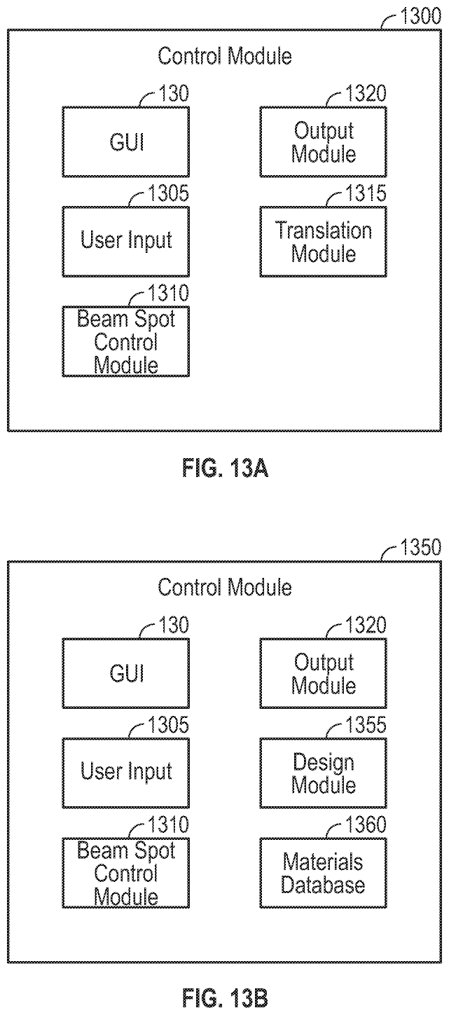

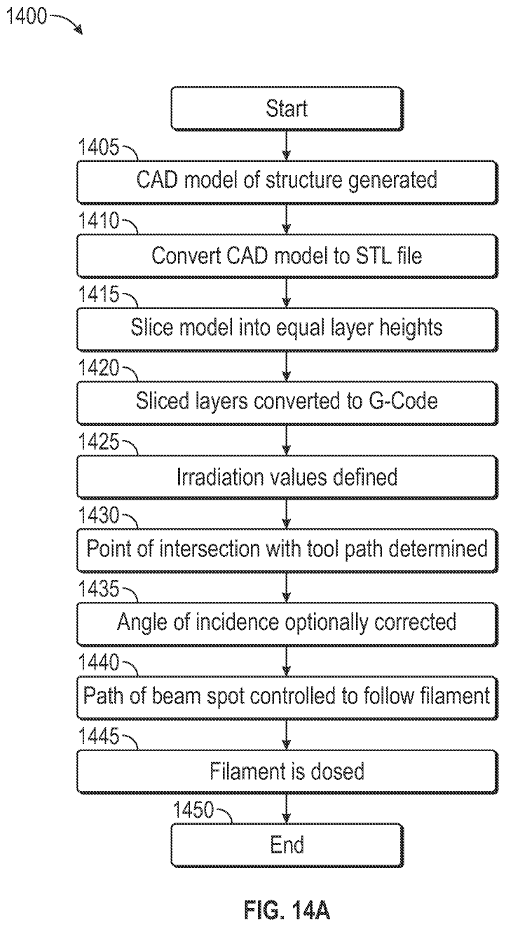

Controlling the position, angle, and power of the particle beam is an aspect of the disclosed embodiments. Control of the systems disclosed herein can be accomplished with a control module 1300 as illustrated in FIG. 13A and control module 1350 illustrated in FIG. 13B. By nature, additive manufacturing processes require the filament material be deposited along a “build path”. As such, the disclosed embodiments, include a control module 1300 or control module 1350 to ensure the proper dose is applied to the filament at the proper time to cure, crosslink, or otherwise treat the filament material. The control module 1300 or control module 1350 can be embodied as software associated with a computer system 100, and can be configured onboard the disclosed systems or can operate to control such systems via wired or wireless communication.

The control module 1300 can include an input module 1305 for receiving build path data associated with a given design program. The control module 1300 can provide a user interface 130 that allows the user to define dosing parameters for the desired application. For example, the input module 1305 can receive design parameters (e.g., a build path) for a project along with a filament material. The user can select a desired dosage for the filament material. In certain embodiments, the dosage can be suggested by the control system according to the design parameters associated with the project including, but not limited to, the filament material, filament size, curing time, and the like.

The control module 1300 can further include a beam spot control module 1310. The beam spot control module 1310 can use the design parameters provided to the control module, to create a path for the beam spot. In certain embodiments, this can include a translation module 1315 that evaluates the location of the nozzle 610 at any given time and builds an associated path for the beam spot.

Once the path for the beam spot is determined, an output module 1320 associated with the control module 1300 can provide instructions to the accelerator assembly to manage the power of the beam spot and to allow the accelerator assembly to direct the location of the beam spot to ensure the filament is properly dosed. The output module 1320 can provide wired or wireless output to the accelerator assembly.

FIG. 13B illustrates another embodiment of the control module 1350. It should be appreciated that control module 1350 incorporates certain aspects of control module 1300. In this embodiment, selection of the desired dosing parameters, flow rates, etc. can occur when the build object is designed in software, sliced, and turned into toolpath information with design module 1355. That software workflow can, for example, accept input parameters relating to the material to be used and can use those parameters to identify the material's requirements stored in a materials database 1360. The control module 1350 can incorporate the flow rate (among other parameters) with the toolpath based on the material requirements. The beam spot control module 1310 can be used to provide another parameter added to the toolpath information.

It should be appreciated that in certain embodiments, the design module 1355 can be embodied as a plug-in, or other such external software module, configured to integrate with or otherwise communicate with an external software application. For example, the design module can integrate with an additive manufacturing software at the slicer level. In such embodiments, the slicer ingests a 3D model (e.g., CAD files), slices them, and outputs G-code (or other such code). One exemplary slicer is Cura, which includes hundreds of user-selectable parameters for additive manufacturing machines, including temperature, print speed, build plate temperature (for desktop printers), “special modes,” etc.

As such, in certain embodiments, the necessary accelerator logic can be built into the slicer node so that it outputs instructions as G-codes. In other embodiments, logic could also be built as a post-processing script that modifies the G-Code output to include accelerator control. In these exemplary embodiments, the completed build code can then be used by the control module 1350 for controlling the beam path.

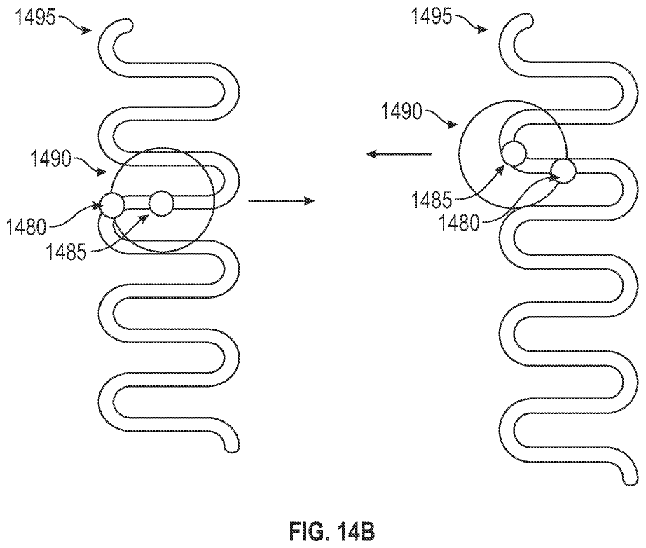

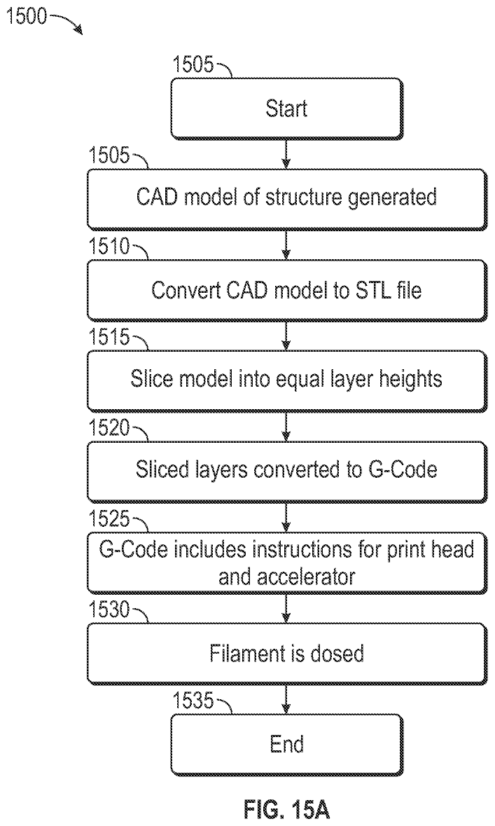

FIG. 14A illustrates a method 1400 for control of a system as disclosed herein. The method begins at 1405. In an exemplary embodiment, the process starts with the generation of a 3D Computer-Aided Design (CAD) model 1410 of the structure. The CAD model can be converted into a Standard Tessellation Language (STL) file format (or other such format) at step 1415 that has the coordinate information of the printed object boundaries. The structure can then be “sliced” into layers with equal layer height at step 1420. The sliced layers are converted into “G-codes” (or other such instruction media) at step 1425 that have the toolpath information for printing.

For concrete FDM, the “toolpath” is the concrete extrusion nozzle's traversal along the 2-dimensional build plane. While extruding, the toolpath defines the shape of the FDM filament. In certain embodiments, a user can define the irradiation values for the filament at step 1430. Irradiation values may depend on the level of curing necessary to impart the desired structure, as outlined by equations 1-3. Thus, the toolpath information includes user-defined irradiation values for the filament.

FIG. 14B provides an exemplary representation of a toolpath. In FIG. 14B, the line 1495 represents the toolpath. The circle 1490 represents the cone-shaped beam extraction device viewed from above (notch not depicted). The center dot 1485 represents the extrusion nozzle viewed from above. The dot 1480 along the circle 1490 represents the electron beam “spot,” which is moved along the periphery of the cone-shaped beam extraction device to follow the toolpath 1495.

Movement of the beam spot is achieved by calculating the point of intersection between the circle and the toolpath as illustrated at step 1435. Depending on the build structure, there may be multiple points of intersection between the toolpath and the circle. Several factors can constrain the suitable points for the beam spot along the circle. For example, the beam spot can “trail” the extrusion nozzle; that is, the configuration of the beam spot can be configured to never intersect with intervals of the toolpath the nozzle hasn't yet traversed. Other points along the circle may serve to speed or slow the traversal—if high dosing of the filament is required, the intersecting point that allows the longest dwell time along an arc of the circle may be desirable.

Angle of incidence around the periphery may be a concern depending on beam energy and thickness of filament (a steep angle of incidence reduces the penetration depth of the beam through the filament). If that is the case, the width of the cone-shaped beam extraction device should be kept as narrow as practicable in order to reduce the angle of incidence. Keeping the extraction device narrow also improves the achievable detail of the printed structure.

If angle of incidence is still a concern, it can be “corrected” magnetically, as shown at 1435. Magnets around the periphery of the cone-shaped beam extraction device as disclosed herein can be permanent magnets or electromagnets; these magnets can “correct” the angle of incidence. Because the angle of incidence is constant around the periphery, a single permanent magnet or electromagnet can be mechanically moved around the periphery to interact with the beam to make it vertical. Alternatively, a static electric field may be applied between the extrusion nozzle and the cone to “correct” the angle of incidence. Alternatively, a conductive plate may be located between the cone and the extrusion nozzle. A static electric field may be applied between this plate and the cone to “correct” the angle of incidence.

The control system can be used to control the path of the beam spot 1440. Once the filament has been adequately dosed at step 1445, the method ends at step 1450.

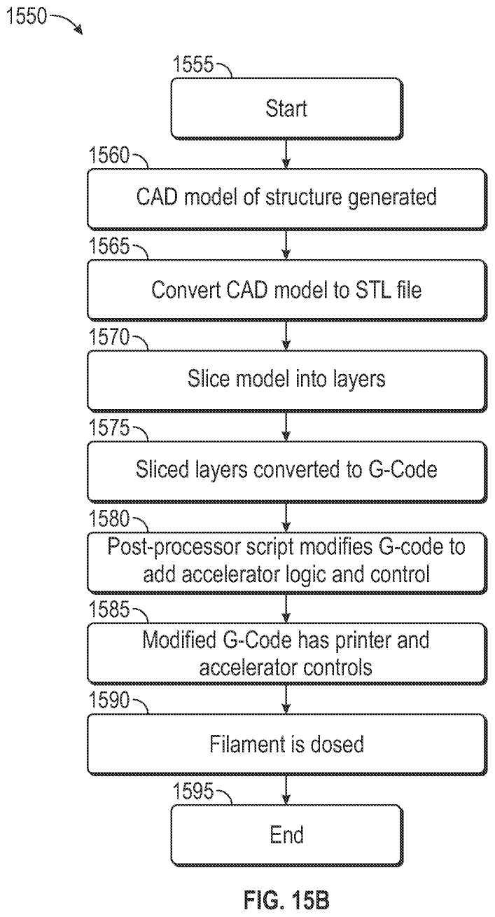

FIG. 15A illustrates a method 1500 for control of a system as disclosed herein. The method begins at 1505. As above, the process starts with the generation of a 3D Computer-Aided Design (CAD) model 1510 of the structure. The CAD model can be converted into a Standard Tessellation Language (STL) file format (or other such format) at step 1515 that has the coordinate information of the printed object boundaries. The structure can then be “sliced” into layers with equal layer height at step 1520.

Irradiation values may depend on the level of curing necessary to impart the desired structure, as outlined by equations 1-3. Thus, in these embodiments, the slicer can ingest the 3D model and incorporate the user defined accelerator parameters, as well as temperature, build speed, etc. such that the accelerator path is built into the G-codes. The sliced layers with associated accelerator parameters are converted into “G-codes” (or other such instruction media) at step 1525. In certain embodiments, the decision logic illustrated in FIG. 14B can be further incorporated into the G-codes. The filament can then be dosed, as illustrated at 1530, and the method ends at 1535.

FIG. 15B illustrates a method 1550 for control of a system as disclosed herein. The method begins at 1555. As above, the process starts with the generation of a 3D Computer-Aided Design (CAD) model 1560 of the structure. The CAD model can be converted into a Standard Tessellation Language (STL) file format (or other such format) at step 1565 that has the coordinate information of the printed object boundaries. The structure can then be “sliced” into layers with equal layer height at step 1570. The sliced layers are converted into “G-codes” (or other such instruction media) at step 1575.

A post processor script can be used to modify the G-code to add accelerator controls and logic as defined herein at step 1580. Thus, the modified G-Code include both printer and accelerator control as illustrated at 1585. The filament can then be dosed as illustrated at 1590 and the method ends at 1595.

Because there is a constant balance between extrudability and buildability, in some cases, it may be desirable to tackify the top layer of the filament without wholly curing it, so that it is easy to extrude and remains malleable, but is also more receptive to additional adjacent layers, and sufficiently stiff to serve as the build platform for adjacent layers. This is essentially the need to increase stiffness while tackifying the surface, thereby improving interface adhesion. In certain embodiments, the method for treating a three dimensional build can take into account the penetrating depth of the associated beam in the build medium, such that multiple layers of filament can be irradiated simultaneously.

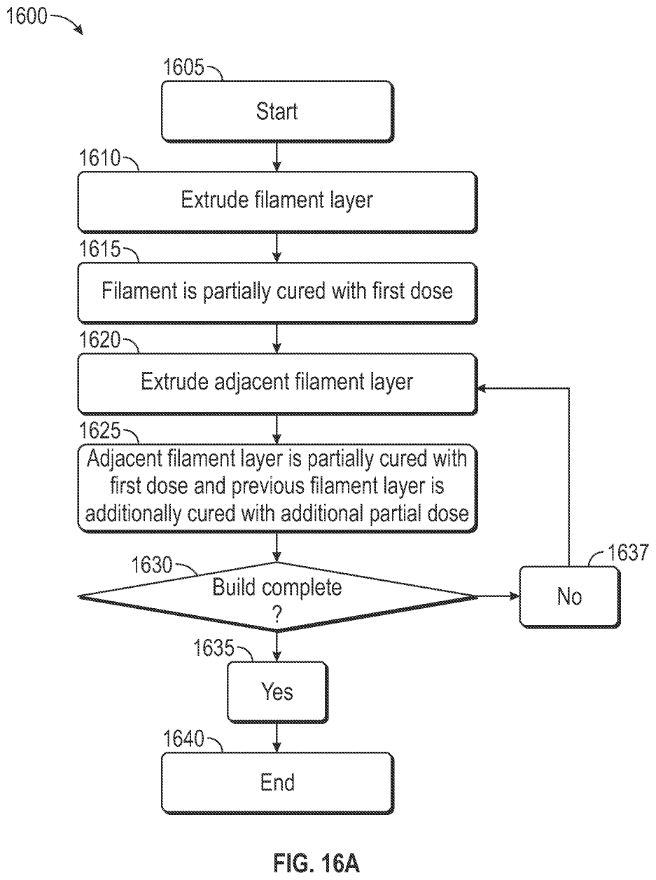

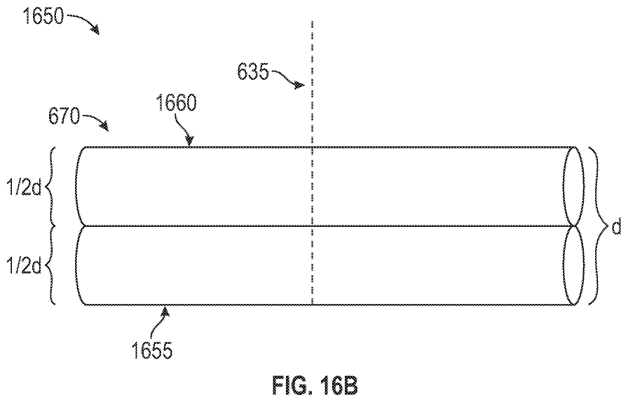

FIGS. 16A and 16B illustrate principles of a method 1600 for curing layers of filament 670 simultaneously in accordance with the disclosed embodiments. FIG. 16A illustrates a method 1600. References are made to FIG. 16B, which provides a diagram illustrating aspects of the treatment of filament. The method begins at 1605

A filament 670 layer 1655 can be extruded onto the build plane as illustrated at step 1610. Although FIG. 16B shows two layers, it should be appreciated that this method can be applied to a build of multiple layers, and to multiple layers of the build. The treatment of two layers is meant to be exemplary. Next at step 1615 the layer 1655 can be partially dosed. The dose of the first layer 1655 can be selected, as disclosed herein, and further according to the desired level of power for curing, penetrating depth of the beam 635 at that power, as well as the thickness of the filament 670.

For example, assume the penetrating depth of the beam 635 (shown as letter “d”) is determined to be 2 cm at a beam power of 10 MeV for the necessary full curing of a layer. Further assume each layer of filament 670 is ½ d (or 1 cm) thick. In this case, the beam power can be reduced by half. As a result, treatment of the filament 670 does not fully cure the first layer 1655. Instead, the layer 1655 receives half the dose necessary for full curing. This stabilizes and tackifies the layer 1655.

At step 1620, a new filament layer 1660 can be extruded adjacent to the partially cured layer 1655. In most cases, the adjacent filament layer 1660 will be on top of the previous layer 1655, but other arrangements are also possible.

At step 1625, the adjacent filament layer 1660 can be dosed at half power. Returning again to the exemplary illustration of FIG. 16B, where the penetrating depth of the beam 635 is 2 cm at 10 MeV for the desired dosing, the dosing of the filament layer 1660 provides half the necessary dose for curing layer 1660. In addition, the penetrating beam 635 provides half the necessary curing of layer 1655, effectively fully dosing layer 1655, which already received a half dose at step 1615.

The method 1600 can iterate as shown at step 1630. If the build is not complete as illustrated by “no” block 1637, the method can return to block 1620 where additional layers can be added to the build and dosed. If the build is complete and all layers of filament 670 have received a full curing dose as shown by “yes” block 1635, the method ends at step 1640.

The disclosed embodiments can be used for high speed low cost 3D builds. In certain embodiments, the disclosed embodiments can facilitate autonomous builds in environments where human presence is untenable. Likewise, the fast curing techniques disclosed herein, can be used to quickly and effectively cure filament slurry that would otherwise be insufficiently viscous for air curing. Likewise, in certain embodiments, filament slurry can be selected that does not require atmospheric curing, which lends itself to build applications in places where little or no air is available to cure the filament.

In another example, embodiments can be used for underwater curing applications including large scale underwater curing applications. It is very difficult to pour concrete underwater for applications such as dams, bridges, etc. Temperature control is one confounding factor, among others. Such applications often require a large volume of concrete. Thus, in certain exemplary applications, the disclosed embodiments can be used to provide energy to concrete filament deposited underwater.

In certain applications, the disclosed embodiments can be used for build solutions in environments with little or no atmosphere to catalyze curing. This could include applications on the moon or on other planets. In such embodiments, sensors for reflected particles and x-ray interrogation with sensors for transmitted particles can be included. In other embodiments, curing of thick extruded carbon fiber composites, fiber glass composites, or other such composites are possible.

In additional embodiments a sprayer can spray a curable adhesive on the base filament just prior to deposition of the subsequent filament, then the adhesive can be cured with the electron beam. This would serve to keep the filaments stuck to each other and seals them together.

In other embodiments, the disclosed system can be used to produce large carbon fiber composites, for wind turbine blades, or other such manufactures. In such embodiments, the only difference is the raw material used. In such embodiments, carbon fiber can be disposed in an epoxy matrix, which can be cured with e-beam. Although the disclosed embodiments may be contemplated with respect to building structures for habitation, it can be used to produce large scale structures of various types. For example, in certain embodiments carbon fiber composites can be fabricated as disclosed herein, for wind turbine blades or other such components. Carbon fiber can be disposed in an epoxy matrix, which can be cured with e-beam. In other examples, the disclosed embodiments can be used to create concrete barriers, watchtowers, bunkers, and entry control points.

Based on the foregoing, it can be appreciated that a number of embodiments, preferred and alternative, are disclosed herein.

In an exemplary embodiment a system comprises a particle source configured to generate a particle beam, a beam extraction assembly, the beam extraction assembly configured to direct the terminal position of the particle beam on a material deposited by a nozzle, and a control system for controlling a beam spot location of the particle beam. In an embodiment, the particle source comprises a particle accelerator. In an embodiment, the particle accelerator comprises an electron beam accelerator. In an embodiment, the particle beam comprises an electron beam.

In an embodiment, the beam extraction assembly comprises a shield cone and a magnet configured to direct the particle beam in the shield cone. In an embodiment, the shield cone further comprises an inner cone, an outer cone, and a cutaway in the shield cone configured to accept the nozzle. In an embodiment the system further comprises a magnet configured in the shield cone to adjust an angle of the particle beam as it exits the shield cone. In an embodiment the system comprises a sensor array configured along the shield cone.

In an embodiment, the beam bending assembly comprises a mechanically rotating assembly for the magnet that rotates about a vertical axis of the beam extraction assembly, bending the particle beam.

In an embodiment of the system, the nozzle comprises an extrusion nozzle associated with an additive manufacturing system. In an embodiment, the beam spot location of the particle beam is directed on a filament deposited by the extrusion nozzle.

In another embodiment, a fabrication method comprises defining a desired build structure, translating the desired build structure into a build path, assigning an irradiation value along the build path sufficient to cure a build material, and delivering a dose of irradiation along the build path according to the assigned irradiation value with a particle beam.

In an embodiment of the method, delivering the dose of irradiation comprises generating the particle beam with a particle accelerator. In an embodiment, the method comprises adjusting a beam angle of the particle beam according to said assigned irradiation value. In an embodiment, the accelerator comprises an electron beam accelerator. In an embodiment, the method comprises directing the particle beam along the build path, wherein the build path is defined by deposition of the build material.

In another embodiment, an apparatus comprises a particle accelerator configured to generate a particle beam, a beam extraction assembly comprising a shield cone and a magnet configured to direct the particle beam in the shield cone, the beam extraction assembly configured to direct the terminal position of the particle beam on a material deposited by a nozzle, and a control system for controlling a beam spot location of the particle beam. In an embodiment of the apparatus, the shield cone further comprises an inner cone, an outer cone, and a cutaway in the shield cone configured to accept the nozzle. In an embodiment of the apparatus, the control system is configured to assign an irradiation value along a build path sufficient to cure the material deposited by the nozzle, and instruct the particle accelerator to deliver a dose of irradiation along the build path according to the assigned irradiation value with the particle beam. In an embodiment, further comprises a window configured between the outer cone and the inner cone.

It should be appreciated that variations of the above-disclosed and other features and functions, or alternatives thereof, may be desirably combined into many other different systems or applications. It should be understood that various presently unforeseen or unanticipated alternatives, modifications, variations, or improvements therein may be subsequently made by those skilled in the art which are also intended to be encompassed by the following claims.

What is claimed is:

1. A system comprising:
a particle source configured to generate a particle beam;
a beam extraction assembly, the beam extraction assembly configured to direct a terminal position of the particle beam on a material deposited by a nozzle; and
a control system for controlling a beam spot location of the particle beam.

2. The system of claim 1 wherein the particle source further comprises:
a particle accelerator.

3. The system of claim 2 wherein the particle accelerator comprises:
an electron beam accelerator.

4. The system of claim 1 wherein the particle beam comprises:
an electron beam.

5. The system of claim 1 wherein the beam extraction assembly comprises:
a shield cone; and
a magnet configured to direct the particle beam in the shield cone.

6. The system of claim 5 wherein the shield cone further comprises:
an inner cone;
an outer cone; and
a cutaway in the shield cone configured to accept the nozzle.

7. The system of claim 5 further comprising:
a magnet configured in the shield cone to adjust an angle of the particle beam as it exits the shield cone.

8. The system of claim 5 further comprising:
a sensor array configured along the shield cone.

9. The system of claim 8 further comprising:
a mechanically rotating assembly for the magnet that rotates about a vertical axis of the beam extraction assembly, bending the particle beam.

10. The system of claim 1 wherein the nozzle comprises an extrusion nozzle associated with an additive manufacturing system.

11. The system of claim 10, wherein the beam spot location of the particle beam is directed on a filament deposited by the extrusion nozzle.

12. A fabrication method comprising:
defining a desired build structure;
translating the desired build structure into a build path;
assigning an irradiation value along the build path sufficient to cure a build material; and
delivering a dose of irradiation along the build path according to the assigned irradiation value with a particle beam.

13. The method of claim 12 wherein delivering the dose of irradiation comprises:
generating the particle beam with a particle accelerator.

14. The method of claim 13 further comprising:
adjusting a beam angle of the particle beam according to the assigned irradiation value.

15. The method of claim 13 wherein the particle accelerator comprises an electron beam accelerator.

16. The method of claim 12 further comprising:
directing the particle beam along the build path, wherein the build path is defined by deposition of the build material.

17. An apparatus comprising:
a particle accelerator configured to generate a particle beam;
a beam extraction assembly comprising a shield cone and a magnet configured to direct the particle beam in the shield cone, the beam extraction assembly configured to direct a terminal position of the particle beam on a material deposited by a nozzle; and
a control system for controlling a beam spot location of the particle beam.

18. The apparatus of claim 17 wherein the shield cone further comprises:
an inner cone;
an outer cone; and
a cutaway in the shield cone configured to accept the nozzle.

19. The apparatus of claim 17 wherein the control system is configured to:
assign an irradiation value along a build path sufficient to cure the material deposited by the nozzle; and
instruct the particle accelerator to deliver a dose of irradiation along the build path according to the assigned irradiation value with the particle beam.

20. The apparatus of claim 18 further comprising:
a window configured between the outer cone and the inner cone.
